(19) United States
(12) Patent Application Publication
(10) Pub. No.: US 2026/0132297 A1
(43) Pub. Date: May 14, 2026

(54) RESIN COMPOSITION, COATED ELECTRIC WIRE, AND WIRE HARNESS

(71) Applicant: Yazaki Corporation, Tokyo (JP)

(72) Inventor: Kyosuke SAITO, Shizuoka (JP)

(73) Assignee: Yazaki Corporation, Tokyo (JP)

(21) Appl. No.: 19/386,818

(22) Filed: Nov. 12, 2025

(30) Foreign Application Priority Data
Nov. 14, 2024 (JP) 2024-199043

(51) Int. Cl. C09D 5/18; C08K 3/22; C08K 3/34; C08K 9/04; C09D 7/48; C09D 7/62; C09D 123/08; H01B 3/44

(52) U.S. Cl. CPC C09D 5/18; C09D 7/48; C09D 7/62; C09D 123/0815; H01B 3/441; C08K 2003/2224; C08K 2003/343; C08K 9/04; C08K 2201/014

(57) ABSTRACT

A resin composition contains a polyolefin resin, a metal hydroxide-based flame retardant, an inorganic filler, and an antioxidant. A content of the metal hydroxide-based flame retardant is 60 parts by mass or more and 140 parts by mass or less with respect to 100 parts by mass of the polyolefin resin. The inorganic filler is formed by using zeolite and an organically modified layered silicate in combination. A content of the zeolite is 0.5 parts by mass or more and 2.0 parts by mass or less with respect to 100 parts by mass of the polyolefin resin. The zeolite has a pore diameter of 3.0 Å or more and 6.5 Å or less, or a pore diameter of more than 6.5 Å and 9.0 Å or less, and has a silica/alumina ratio of 2 or more and 10 or less. A content of the organically modified layered silicate is 1.0 part by mass or more and 14.0 parts by mass or less with respect to 100 parts by mass of the polyolefin resin.

### CROSS-REFERENCE TO RELATED APPLICATIONS

The present application is based on, and claims priority from Japanese Patent Application No. 2024-199043, filed on Nov. 14, 2024, the entire contents of which are incorporated herein by reference.

### TECHNICAL FIELD

The present disclosure relates to a resin composition, a coated electric wire, and a wire harness.

### BACKGROUND

In the related art, as a coated electric wire arranged for automotive use, an electric wire in which a coating layer formed of a resin composition containing a thermoplastic resin is used. In particular, among thermoplastic resins, a polyolefin-based resin is widely used from the viewpoints of cost and availability. When the polyolefin-based resin is subjected to a crosslinking treatment, the polyolefin-based resin can also be applied to an electric wire assumed to be used in a higher-temperature environment.

In recent years, as a technological trend, momentum toward a transition to electric vehicles has been increasing. One of the issues of electric vehicles is improvement in cruising range, and studies to increase battery capacity have been progressing. Along with this, since it is necessary to shorten charging time by increasing current, it is required to increase the size of electric wires that are component members of a wire harness, and electric wires applicable to higher temperatures with respect to heat resistance of the electric wires are demanded. On the other hand, in view of environmental regulations, it is assumed that fuel efficiency regulations will also become stricter year by year. In order to achieve compatibility between these issues, thickness reduction of an insulator covering an electric wire conductor is required. As issues associated with such thickness reduction, long-term heat resistance and thermal deformation properties are mentioned.

In recent years, from the viewpoint of suppressing load on the global environment, use of inorganic flame retardants such as metal hydroxides has been studied. However, in order to achieve flame retardancy equivalent to that of brominated flame retardants, a high loading amount is required. Since it is known that metal cations promote oxidative degradation of resins, there is a concern that addition in a large amount may lead to deterioration in long-term heat resistance. As a measure for improving long-term heat resistance, an increase in the amount of an antioxidant is generally considered first, However, since bleed-out or blooming of the antioxidant is likely to occur, particularly in electric wire applications, there is a concern that deviation in wire length of an electric wire may occur, leading to product defects. Accordingly, for example, JP 2003-197040 A discloses a resin composition in which magnesium hydroxide is added as a flame retardant and an organoclay is further added, thereby suppressing bleed-out of an antioxidant.

### SUMMARY OF THE INVENTION

However, as in JP 2003-197040 A, addition of an organoclay alone is insufficient to provide heat resistance. As described above, there is a problem in that a formulation that can achieve both heat resistance and bleed resistance while using an inorganic flame retardant has not yet been established.

The present disclosure has been made in view of such problems in the related art. Further, an object of the present disclosure is to provide
a resin composition having sufficient heat resistance and bleed resistance for use as a coating layer of an electric wire, and a coated electric wire and a wire harness that use the resin composition.

A resin composition according to an aspect of the present disclosure is a resin composition containing a polyolefin resin, a metal hydroxide-based flame retardant, an inorganic filler, and an antioxidant. A content of the metal hydroxide-based flame retardant is 60 parts by mass or more and 140 parts by mass or less with respect to 100 parts by mass of the polyolefin resin. The inorganic filler is formed by using zeolite and an organically modified layered silicate in combination. A content of the zeolite is 0.5 parts by mass or more and 2.0 parts by mass or less with respect to 100 parts by mass of the polyolefin resin. The zeolite has a pore diameter of 3.0 Å or more and 6.5 Å or less, or a pore diameter of more than 6.5 Å and 9.0 Å or less, and has a silica/alumina ratio of 2.0 or more and 10.0 or less. A content of the organically modified layered silicate is 1.0 part by mass or more and 14.0 parts by mass or less with respect to 100 parts by mass of the polyolefin resin.

A coated electric wire according to another aspect of the present disclosure includes a conductor, and a coating layer that covers the conductor and contains the resin composition.

A wire harness according to another aspect of the present disclosure includes the coated electric wire.

According to the present disclosure, it is possible to provide a resin composition having sufficient heat resistance and bleed resistance for use as a coating layer of an electric wire, and a coated electric wire and a wire harness that use the resin composition.

### BRIEF DESCRIPTION OF DRAWINGS

FIGURE is a cross-sectional view schematically illustrating an example of a coated electric wire according to the present embodiment.

### DETAILED DESCRIPTION OF THE INVENTION

With reference to the drawing, a resin composition, a coated electric wire, and a wire harness according to the present embodiment are described below in detail. Note that the dimensional ratios in the drawing are exaggerated for explanatory purposes, and may differ from the actual ratios.

### [Resin Composition]

A resin composition according to the present embodiment contains a polyolefin resin, a metal hydroxide-based flame retardant, an inorganic filler, and an antioxidant.

### (Polyolefin Resin)

The polyolefin resin is a polymer of a monomer containing an olefin. The polyolefin resin may be a homopolymer of an olefin, or may be a copolymer of an olefin and a monomer other than an olefin. The homopolymer of an olefin may be a polymer of one type of olefin, or may be a polymer of two or more types of olefins. The polyolefin resin may be modified with maleic acid or the like, or may be unmodified.

The olefin may include an α-olefin, a β-olefin, and a γ-olefin. The α-olefin may include at least one monomer selected from the group consisting of ethylene, propylene, 1-butene, 1-pentene, 1-hexene, 4-methyl-1-pentene, 1-octene, and 1-decene.

The monomer other than an olefin may be a monomer having a carbon-carbon double bond. The monomer other than an olefin may include at least one of styrene and an acrylate.

The polyolefin resin may be at least one selected from the group consisting of low-density polyethylene (LDPE), linear low-density polyethylene (LLDPE), high-density polyethylene (HDPE), homopolypropylene (homo-PP), random polypropylene (random PP), block polypropylene (block PP), an ethylene-butene copolymer, and an ethylene-propylene-butene copolymer.

The polyolefin resin may be an ethylene copolymer resin polymerized by using an ethylene monomer and a comonomer other than the ethylene monomer. The ethylene copolymer resin is a copolymer of an ethylene monomer and an olefin-based monomer other than the ethylene monomer in an amount of more than 5 mol %, and a copolymer of an ethylene monomer and a non-olefin-based monomer in an amount of more than 1 mol %. Examples of the ethylene copolymer resin include an ethylene-vinyl ester copolymer, an ethylene-α,β-unsaturated carboxylic acid and/or alkyl ester thereof copolymer, an ethylene-vinyl acetate copolymer (EVA), an ethylene-methyl methacrylate copolymer (EMMA), an ethylene-ethyl acrylate copolymer (EEA), an ethylene-methyl acrylate copolymer (EMA), an ethylene-butyl acrylate copolymer (EBA), and an ethylene-vinyl acetate-ethyl acrylate copolymer. Those ethylene copolymer resins may be used alone, or two or more types thereof may be used in combination. Further, the ethylene copolymer resin may be modified with maleic acid, maleic anhydride, or the like, or may be unmodified.

### (Metal Hydroxide-Based Flame Retardant)

The resin composition contains the metal hydroxide-based flame retardant in order to improve flame retardancy. Examples of the metal hydroxide-based flame retardant include magnesium hydroxide (Mg(OH)₂), aluminum hydroxide (Al(OH)₃), calcium hydroxide (Ca(OH)₂), basic magnesium carbonate (mMgCO₃·Mg(OH)₂·nH₂O), hydrated aluminum silicate (aluminum silicate hydrate, Al₂O₃·3SiO₂·nH₂O), and hydrated magnesium silicate (magnesium silicate pentahydrate, Mg₂Si₃O₈·5H₂O), and one or more metal compounds having hydroxyl groups or crystal water can be used. Among those, magnesium hydroxide is particularly preferable as the metal hydroxide.

A content of the metal hydroxide-based flame retardant in the resin composition is 60 parts by mass or more and 140 parts by mass or less, preferably, 60 parts by mass or more and 120 parts by mass or less with respect to 100 parts by mass of the polyolefin resin. When the content of the metal hydroxide-based flame retardant is 60 parts by mass or more, flame retardancy of the resin composition can be improved. Further, when the content of the metal hydroxide-based flame retardant is 140 parts by mass or less, adverse effects on heat resistance and mechanical properties of the resin composition can be avoided.

### (Zeolite)

The resin composition contains the inorganic filler. Further, the inorganic filler is formed by using zeolite and an organically modified layered silicate in combination.

By adding the zeolite to the resin composition, a temperature at which the resin composition decomposes can be increased. The zeolite is a type of aluminosilicate, and can be represented by a general formula M_{x/n}·[(AlO₂)ₓ·(SiO₂)_{y}]·zH₂O. Note that, in the general formula, M is a cation having a valence of n, x+y represents the number of tetrahedra per unit cell, z represents the number of moles of water, and y is a value greater than x. Examples of monovalent cation species include Li⁺, Na⁺, and K⁺, and examples of divalent cation species include Ca²⁺, Mg²⁺, and Ba²⁺.

In general, the zeolite is porous, and has pores. The zeolite is capable of adsorbing molecules smaller than the pore diameter. However, since molecules larger than the pore diameter cannot enter the pores, it is known that the zeolite has a molecular sieve effect and an ion exchange function.

In the present embodiment, the zeolite has a pore diameter of 3.0 Å or more and 9.0 Å or less. By using the zeolite, consumption of the antioxidant can be moderated, and oxidation inhibition efficiency with respect to the added amount can be improved.

Examples of cation species of the zeolite include hydrogen ions (H⁺), potassium ions (K⁺), calcium ions (Ca²⁺), and ammonium ions (NH₄⁺). With respect to the cation species of the zeolite, effects on thermal decomposition behavior of the polyolefin resin differ depending on differences in the type thereof. From the viewpoint of improving a thermal decomposition temperature of the polyolefin resin, cation species such as NH₄⁺, K⁺, and Ca²⁺, which suppress an effect of the zeolite as a solid acid catalyst, are preferable.

An average particle diameter of the zeolite is not particularly limited, but is preferably 0.1 μm to 50 μm, more preferably 1 μm to 30 μm, and still more preferably 5 μm to 20 μm. The average particle diameter of the zeolite can be measured by observing a cross section of the resin composition by using a scanning electron microscope (SEM) or the like.

The zeolite includes natural zeolite, synthetic zeolite, and artificial zeolite. Natural zeolite is produced in nature, and has characteristics such as being inexpensive in many cases. Synthetic zeolite is produced using high-purity chemical substances as raw materials, and has characteristics such as high purity. Artificial zeolite is produced using unused resources typified by coal ash as raw materials, and has characteristics such as having higher purity than natural zeolite and being less expensive than synthetic zeolite. Among those, the zeolite is preferably at least one of synthetic zeolite and artificial zeolite. This is because those types of zeolite have a more uniform structure as compared to natural zeolite, and control of thermal decomposition of a thermoplastic resin is relatively easy.

A structure of the zeolite is not particularly limited. Examples of the structure of the zeolite include A-type, beta-type, MCM-22-type, ZSM-5-type, Y-type, ferrierite-type, and mordenite-type.

The pore diameter of the zeolite is derived from a crystal structure of the zeolite. Note that the pore diameter of the zeolite can be measured by, for example, the Horvath-Kawazoe method. When the pore diameter of the zeolite is 6.5 Å or less, a ratio of silica to alumina in the zeolite, that is, a SiO₂/Al₂O₃ ratio (hereinafter, referred to as a silica/alumina ratio), is not particularly limited, and is, for example, 2 or more and 10,000 or less.

On the other hand, when the pore diameter of the zeolite is more than 6.5 Å and 9.0 Å or less, from the viewpoint of heat resistance of the resin composition, the silica/alumina ratio is 2 or more and 10 or less.

The zeolite has hygroscopic properties as a characteristic, and there is a concern that a moisture content in the resin may be increased with an increase in an added amount thereof. Thus, the content of the zeolite in the resin composition is 0.5 parts by mass or more and 2.0 parts by mass or less with respect to 100 parts by mass of the polyolefin resin. When the content of the zeolite is 0.5 parts by mass or more, heat resistance of the resin composition can be improved. Further, when the content of the zeolite is 2.0 parts by mass or less, water absorption of the resin composition can be suppressed. On the other hand, when the zeolite is added in a high loading amount, there is a concern that thermal degradation of the resin may be promoted. Thus, a ratio of the content of the zeolite to the content of the antioxidant is preferably 0.08 or more and 3.0 or less, and more preferably 0.08 or more and 1.0 or less. By setting the ratio of the content of the zeolite to the content of the antioxidant within the above range, it is possible to secure heat resistance of the resin composition while maintaining bleed resistance and minimizing an added amount of the antioxidant. Further, it is possible to prolong a time during which the antioxidant is consumed during heat treatment, thereby improving heat resistance of the resin composition.

### (Organically Modified Layered Silicate)

The inorganic filler may be formed by using the zeolite and the organically modified layered silicate in combination. The organically modified layered silicate is a layered silicate subjected to organic modification. By exfoliating and dispersing the organically modified layered silicate in the polyolefin resin, it is possible to improve a long-term heat resistance life of a coated electric wire coated by using the resin composition, and further to improve thermal deformation properties by physically suppressing deformation. In other words, by using the zeolite and the organically modified layered silicate in combination in the resin composition, it is possible to achieve compatibility among bleed resistance, heat resistance, and low thermal deformation properties.

Examples of the layered silicate include bentonite, smectite, hectorite, montmorillonite, mica, talc, and kaolin. The organically modified layered silicate can be produced by causing an ion exchange reaction between inorganic cations of the layered silicate and an organic modifier. Examples of the organic modifier include organic phosphonium salts, alkylammonium salts, and organic onium salts. From the viewpoint of heat resistance of the resin composition, the organically modified layered silicate is preferably bentonite or smectite modified with an organic onium salt, more preferably trimethylstearylammonium bentonite.

When the inorganic filler is formed by using the zeolite and the organically modified layered silicate in combination, a content of the organically modified layered silicate is 1.0 part by mass or more and 14.0 parts by mass or less with respect to 100 parts by mass of the polyolefin resin. When the content of the organically modified layered silicate is 1.0 part by mass or more, it is possible to achieve compatibility among bleed resistance, heat resistance, and low thermal deformation properties of the resin composition. Further, when the content of the organically modified layered silicate is 14.0 parts by mass or less, it is possible to prevent adverse effects on heat resistance of the resin composition.

### (Antioxidant)

Since oxidative degradation of a resin is promoted by adding the metal hydroxide-based flame retardant in a high loading amount, it is necessary to improve long-term heat resistance with the antioxidant. Examples of the antioxidant include a phenolic antioxidant that scavenges radicals, a phosphorus-based antioxidant that decomposes peroxides, and a sulfur-based antioxidant. In order to impart sufficient heat resistance to the resin composition as the antioxidant, an antioxidant such as a hindered phenol (a primary antioxidant) and a sulfur-based antioxidant such as a thioether (a secondary antioxidant) may be used in combination.

As an added amount of the primary antioxidant is increased, oxidative degradation of a resin can be suppressed more. However, there is a concern that excessive addition may cause bleed-out, or may react during a crosslinking treatment to lead to a decrease in a degree of crosslinking. Thus, a content of the primary antioxidant is preferably 1 part by mass or more and 6 parts by mass or less with respect to 100 parts by mass of the polyolefin resin. When the content of the primary antioxidant is 1 part by mass or more, it is possible to impart a sufficient heat resistance life. Further, when the content of the primary antioxidant is 6 parts by mass or less, it is possible to suppress bleed-out of the antioxidant to a surface of an insulating layer of an electric wire, thereby preventing adverse effects on workability during manufacture of the electric wire.

The secondary antioxidant exhibits a synergistic effect when used in combination with the primary antioxidant. However, similarly to the primary antioxidant, there is a concern that excessive addition may cause bleed-out, and may also lead to deterioration in smoke generation characteristics of an electric wire. Thus, a content of the secondary antioxidant is preferably 1 part by mass or less with respect to 100 parts by mass of the polyolefin resin. When the content of the secondary antioxidant is 1 part by mass or less, it is possible to suppress bleed-out of the antioxidant to a surface of an insulating layer of the electric wire.

### (Other Additives)

Examples of additives other than the metal hydroxide-based flame retardant, the zeolite, the organically modified layered silicate, and the antioxidant described above include a crosslinking agent, a crosslinking aid, a processing aid, a plasticizer, a copper damage inhibitor, a metal deactivator, a filler, a reinforcing agent, an ultraviolet light absorber, a stabilizer, a pigment, a lubricant, a dye, a colorant, an antistatic agent, and a foaming agent.

In the present embodiment, the polyolefin resin in the resin composition may be crosslinked. By crosslinking the polyolefin resin, heat resistance of the resin composition can be improved. A method for crosslinking the polyolefin resin is not particularly limited. For example, the polyolefin resin may be crosslinked through irradiation with radiation, or the polyolefin resin may be crosslinked by a crosslinking agent contained in the resin composition. Note that the polyolefin resin is preferably radiation-crosslinked.

Examples of radiation used for crosslinking include γ-rays and electron beams. By irradiating a coating layer with radiation, radicals are generated in molecules, and crosslinking bonds between molecules are formed. Irradiation conditions of the radiation are not particularly limited. For example, an accelerating voltage is 500 kV to 1000 kV, and an irradiation dose is 100 kGy to 250 kGy.

As the crosslinking agent, an organic peroxide or the like can be used. Examples of the crosslinking agent include dicumyl peroxide, di-tert-butyl peroxide, 2,5-dimethyl-2,5-di(tert-butylperoxy)hexane, 2,5-dimethyl-2,5-di(tert-butylperoxy)hexyne-3, 1,3-bis(tert-butylperoxyisopropyl)benzene, 1,1-bis(tert-butylperoxy)-3,3,5-trimethylcyclohexane, n-butyl-4,4-bis(tert-butylperoxy)valerate, benzoyl peroxide, 2,4-dichlorobenzoyl peroxide, tert-butyl peroxybenzoate, tert-butyl peroxyisopropyl carbonate, diacetyl peroxide, lauroyl peroxide, and tert-butyl cumyl peroxide, and at least one selected from the group consisting of those may be used. The crosslinking agent may be used alone, or two or more types thereof may be used in combination. Note that, in the resin composition, a content of the crosslinking agent is preferably 0.05 to 0.10 parts by mass with respect to 100 parts by mass of the polyolefin resin.

The resin composition may further contain, in addition to the crosslinking agent, the crosslinking aid in order to improve crosslinking efficiency. As the crosslinking aid, a polyfunctional compound can be used. The crosslinking aid may be at least one compound selected from the group consisting of acrylate compounds, methacrylate compounds, allyl compounds, and vinyl compounds. Those polyfunctional compounds may be used alone, or two or more types thereof may be used in combination. Note that, among those compounds, trimethylolpropane trimethacrylate is preferably used because it has high affinity with the polyolefin resin.

Further, a content of the crosslinking aid in the resin composition is preferably 0.1 parts by mass to 5 parts by mass, and more preferably 0.8 parts by mass to 2 parts by mass, with respect to 100 parts by mass of the polyolefin resin. By setting the content within such ranges, it is possible to further improve heat resistance, processability, and bleed resistance of the resin composition.

Examples of the processing aid include petroleum-based oils such as paraffinic oils and naphthenic oils that are added to rubber materials.

The resin composition is produced by melt-kneading the polyolefin resin, the metal hydroxide-based flame retardant, and the like that are described above, and a publicly-known method can be used as the method therefor. For example, after pre-blending using a high-speed mixing apparatus such as a Henschel mixer, kneading may be performed using a publicly-known kneading machine such as a Banbury mixer, a kneader, and a roll mill, and, as described above, by crosslinking the polyolefin resin, the resin composition can be obtained.

As described above, the resin composition contains the polyolefin resin, the metal hydroxide-based flame retardant, the inorganic filler, and the antioxidant. The content of the metal hydroxide-based flame retardant is 60 parts by mass or more and 140 parts by mass or less with respect to 100 parts by mass of the polyolefin resin. The inorganic filler is formed by using the zeolite and the organically modified layered silicate in combination. The content of the zeolite is 0.5 parts by mass or more and 2.0 parts by mass or less with respect to 100 parts by mass of the polyolefin resin. The zeolite has a pore diameter of 3.0 Å or more and 6.5 Å or less, or a pore diameter of more than 6.5 Å and 9.0 Å or less, and has a silica/alumina ratio of 2 or more and 10 or less. The content of the organically modified layered silicate is 1.0 part by mass or more and 14.0 parts by mass or less with respect to 100 parts by mass of the polyolefin resin. Thus, the resin composition has sufficient heat resistance and bleed resistance for use as a coating layer of an electric wire.

### [Coated Electric Wire]

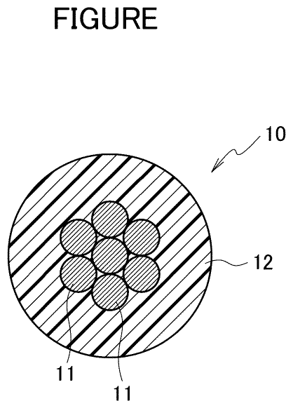

FIG. 1s a cross-sectional view illustrating an example of a coated electric wire 10 according to the present embodiment. As illustrated in FIGURE, the coated electric wire 10 of the present embodiment includes a conductor 11 and a coating layer 12 that covers the conductor 11 and contains the resin composition according to the above-mentioned embodiment. The resin composition according to the above-mentioned embodiment has sufficient heat resistance and bleed resistance for use as a coating layer of an electric wire. Thus, the coated electric wire 10 including the coating layer 12 described above can be preferably used, for example, as the coated electric wire 10 for an automobile.

The conductor 11 may be formed of a single element wire, or may be a bunched stranded wire formed of a bundle of a plurality of element wires. Further, the conductor 11 may be formed of a single stranded wire, or may be a composite stranded wire formed of a bundle of a plurality of bunched stranded wires. A configuration and a size of the conductor 11 are preferably a configuration and a size specified in at least one of JASO D624 and ISO 19642-5.

A diameter of the conductor 11 is not particularly limited, but is preferably 4.0 mm or more, and more preferably 5.0 mm or more. By setting the diameter of the conductor 11 as described above, resistance of the conductor can be reduced, and, for example, even when a large-capacity battery is used, a charging time can be shortened. Further, the diameter of the conductor 11 is not particularly limited, but is preferably 25 mm or less, and more preferably 20 mm or less. By setting the diameter of the conductor 11 as described above, routing of the coated electric wire 10 can be facilitated even in a narrow and short path.

A diameter of the element wire is not particularly limited, but is preferably 0.1 mm or more, and more preferably 0.2 mm or more. By setting the diameter of the element wire as described above, breakage of the element wire can be suppressed. Further, the diameter of the element wire is not particularly limited, but is preferably 0.5 mm or less, and more preferably 0.4 mm or less. By setting the diameter of the element wire as described above, routing of the coated electric wire 10 can be facilitated even in a narrow and short route.

A material forming the conductor 11 is not particularly limited, but is preferably at least one conductive metal material selected from the group consisting of copper, a copper alloy, aluminum, and an aluminum alloy.

A thickness of the coating layer 12 is not particularly limited, but is preferably 0.5 mm or more, and more preferably 0.65 mm or more. By setting the thickness of the coating layer 12 as described above, the conductor 11 can be effectively protected. Further, the thickness of the coating layer 12 is not particularly limited, but is preferably 2.0 mm or less, and more preferably 1.85 mm or less. By setting the thickness of the coating layer 12 as described above, routing of the coated electric wire 10 can be facilitated even in a narrow and short route.

The coated electric wire 10 may further include a shield layer that covers the coating layer 12, and a sheath layer that further covers the shield layer. The shield layer can prevent emission of unnecessary electromagnetic waves from the conductor 11. The shield layer can be formed by braiding a conductive metal foil or a foil containing metal, or metal wires (metal conductors) into a mesh shape. The sheath layer can effectively protect and bundle the shield layer. The sheath layer is not particularly limited, and may be formed by using an olefin resin such as polyethylene, or may be formed by using the resin composition according to the above-mentioned embodiment.

As a method for covering the conductor 11 with the coating layer 12, a publicly-known means can be adopted. For example, the coating layer 12 can be formed by a general extrusion molding method. Further, as an extruder used in the extrusion molding method, for example, a single-screw extruder or a twin-screw extruder including a screw, a breaker plate, a crosshead, a distributor, a nipple, and dies can be used.

When producing the resin composition forming the coating layer 12, the polyolefin resin, a flame retardant, the inorganic filler, and the antioxidant are charged into an extruder set to a temperature at which the resin sufficiently melts. In this state, other additives are also charged into the extruder as necessary. Then, the resin composition is melted and kneaded by the screw, and a predetermined amount thereof is supplied to the crosshead via the breaker plate. The molten resin composition flows onto a circumference of the nipple by the distributor, and is extruded by the dies in a state of being coated on an outer periphery of the conductor 11, whereby the coating layer 12 that covers the outer periphery of the conductor 11 can be obtained.

As described above, in the coated electric wire 10 of the present embodiment, the coating layer 12 can be formed by extrusion molding in the same manner as a general resin composition for electric wires. Note that, in order to improve strength of the coating layer 12, after the coating layer 12 is formed on the outer periphery of the conductor 11, the resin composition may be crosslinked by a method such as irradiation with radiation described above.

### [Wire Harness]

A wire harness according to the present embodiment includes the coated electric wire 10. The resin composition according to the above-mentioned embodiment has sufficient heat resistance and bleed resistance for use as a coating layer of an electric wire. Thus, the coated electric wire 10 including the coating layer 12 formed of the resin composition described above can be preferably used, for example, as a wire harness in an engine room for an automobile.

### EXAMPLES

Hereinafter, the present embodiment is described in more detail with reference to examples and comparative examples. However, the present embodiment is not limited to these examples.

### (Polyolefin Resin)

ENGAGE (registered trademark) 7256, manufactured by Dow Chemical Japan Ltd., an ethylene-butene copolymer

### (Metal Hydroxide-Based Flame Retardant)

KISUMA (registered trademark) 5A, manufactured by Kyowa Chemical Industry Co., Ltd., magnesium hydroxide subjected to a stearic acid surface treatment

### (Antioxidant)

Antioxidant 1: IRGANOX (registered trademark) 1010, manufactured by BASF SE, a hindered phenol-based antioxidant (the primary antioxidant)
Antioxidant 2: NOCRAC (registered trademark) 400, manufactured by Ouchi Shinko Chemical Industrial Co., Ltd., a sulfur-based antioxidant (the secondary antioxidant)

### (Copper Corrosion Inhibitor)

IRGANOX (registered trademark) MD1024, manufactured by BASF SE, a hydrazine-based copper corrosion inhibitor

### (Zeolite)

A-type zeolite: ZEORAM (registered trademark) A-5, manufactured by Tosoh Corporation, a pore diameter of 5 Å, a silica/alumina ratio of 2
Beta-type zeolite: HSZ (registered trademark) 940HOA, manufactured by Tosoh Corporation, a pore diameter of 6.5 Å, a silica/alumina ratio of 40
Y-type zeolite 1: HSZ 320HOA, manufactured by Tosoh Corporation, a pore diameter of 9 Å, a silica/alumina ratio of 5.5
Y-type zeolite 2: HSZ 385HUA, manufactured by Tosoh Corporation, a pore diameter of 9 Å, a silica/alumina ratio of 100

### (Organically Modified Layered Silicate)

Organically modified bentonite: KUNIBIS (registered trademark)-110, manufactured by Kunimine Industries Co., Ltd., trimethylstearylammonium bentonite
Purified bentonite: KUNIPIA (registered trademark)-F, manufactured by Kunimine Industries Co., Ltd.
Mica: M-XF, manufactured by Repco Inc.
Calcined kaolin clay: ST-100, manufactured by Shiraishi Calcium Kaisha, Ltd.
Wollastonite (calcium silicate): ST-40FK, manufactured by Shiraishi Calcium Kaisha, Ltd.

### [Evaluation]

With respect to the resin composition, properties of the examples and the comparative examples were evaluated by the following methods. Based on the formulations (unit: parts by mass) shown in Table 1 and Table 2, the resin composition subjected to a crosslinking treatment by electron beam irradiation under a condition of 750 kV×160 kGy was used as a test sample, and electric wire heat resistance, bleed resistance, thermal deformation properties, and water absorption were evaluated. The evaluation results are shown in Table 1 and Table 2.

### (Electric Wire Heat Resistance)

A test sample was prepared by producing an electric wire having a conductor outer diameter of 2.1 to 2.2 mm and a coating layer thickness of 0.4 mm, performing a crosslinking treatment, and then cutting the electric wire into a length of 200 mm. The test sample was placed in a gear oven set at a temperature of 170° C., and heat treatment was performed for a predetermined time. Thereafter, the test sample was taken out from the gear oven and left to stand at a room temperature (approximately 23° C.) for 12 hours. Further, the test sample after the heat treatment was wound around a mandrel having an outer diameter 1.5 times an outer diameter of the finished electric wire, and a heat treatment time required until cracking occurred was determined. A case in which no cracking occurred even after heating at 170° C. for 250 hours was evaluated as “pass”, and a case in which cracking occurred due to heating at 170° C. for 250 hours or less than 250 hours was evaluated as “fail”.

### (Bleed Resistance)

A test sample was prepared by molding the resin composition into a resin sheet having a thickness of 0.5 mm and a width of 50 mm, and then cutting the resin sheet into a length of 200 mm. After wiping the resin sheet with acetone, the resin sheet was left to stand for 1,000 hours under conditions of a room temperature (23° C.) and humidity of 40 to 60%. Then, the resin sheet was wiped again with acetone, and a weight change before and after wiping was measured. Then, a bleed amount per unit area (mg/cm²) was calculated by using values of the length and the width of the resin sheet. A case in which the measured weight change was less than 0.150 mg/cm² was evaluated as “pass”, and a case in which the measured weight change was 0.150 mg/cm² or more was evaluated as “fail”.

### (Thermal Deformation Properties)

A test sample was prepared by molding the resin composition into a resin sheet having a thickness of 2 mm, and then cutting the resin sheet into a size specified in JIS K6723 6.5 (thermal deformation test). Measurement was performed by preheating the test sample at a temperature of 150° C. for 30 minutes, and then applying a load of 9.8067 N at a temperature of 150° C. for 30 minutes, followed by measuring a thermal deformation ratio from an initial thickness. A case in which the measured thermal deformation ratio was 8.0% or less was evaluated as “pass”, and a case in which the measured thermal deformation ratio was higher than 8.0% was evaluated as “fail”.

### (Water Absorption)

As test samples, pellets obtained by pelletizing the resin composition were used. The pellets were subjected to vacuum degassing by using a vacuum dryer at a temperature of 40° C., and then prepared by leaving the pellets under conditions of a room temperature (23° C.) and humidity of 40 to 60% for 168 hours. Measurement was performed in accordance with JIS K7251: 2002 (Plastics-Determination of moisture content) using Method A (anhydrous methanol extraction method). A case in which the measured moisture content was less than 1,500 ppm was evaluated as “pass”, and a case in which the measured moisture content was 1,500 ppm or more was evaluated as “fail”.

TABLE 1

| | | Exam- | Exam- | Exam- | Exam- | Exam- | Exam- | Exam- | Exam- | Exam- | Exam- |
|---|---|---|---|---|---|---|---|---|---|---|---|
| | | ple | ple | ple | ple | ple | ple | ple | ple | ple | ple |
| | | 1 | 2 | 3 | 4 | 5 | 6 | 7 | 8 | 9 | 10 |
| Polyolefin resin | | 100 | 100 | 100 | 100 | 100 | 100 | 100 | 100 | 100 | 100 |
| Metal hydroxide-based flame | | 60 | 60 | 60 | 140 | 60 | 60 | 60 | 60 | 60 | 60 |
| retardant | | | | | | | | | | | |
| Antioxidant 1 | | 1 | 1 | 1 | 1 | 2 | 5 | 1 | 4 | 1 | 1 |
| Antioxidant 2 | | 1 | 1 | 1 | 1 | 1 | 1 | 1 | 1 | 1 | 1 |
| Copper inhibitor | | 0.6 | 0.5 | 0.5 | 0.5 | 0.5 | 0.5 | 0.5 | 0.5 | 0.6 | 0.6 |
| A-type zeolite | | 0.5 | 0.5 | 0.5 | 0.5 | 0.5 | 0.5 | 2 | 0.5 | | |
| Beta-type zeolite | | | | | | | | | | 0.5 | |
| Y-type zeolite 1 | | | | | | | | | | | 0.5 |
| Y-type zeolite 2 | | | | | | | | | | | |
| Organically modified bentonite | | 5 | 1 | 14 | 5 | 5 | 5 | 5 | 5 | 5 | 5 |
| Purified bentonite | | | | | | | | | | | |
| Mica | | | | | | | | | | | |
| Calcined kaolin clay | | | | | | | | | | | |
| Wollastonite | | | | | | | | | | | |
| Evaluation | Electric wire heat | Pass | Pass | Pass | Pass | Pass | Pass | Pass | Pass | Pass | Pass |
| | resistance | | | | | | | | | | |
| | Bleed resistance | Pass | Pass | Pass | Pass | Pass | Pass | Pass | Pass | Pass | Pass |
| | Thermal deformation | Pass | Pass | Pass | Pass | Pass | Pass | Pass | Pass | Pass | Pass |
| | properties | | | | | | | | | | |
| | Water absorption | Pass | Pass | Pass | Pass | Pass | Pass | Pass | Pass | Pass | Pass |

TABLE 2

| | | Comparative | Comparative | Comparative | Comparative | Comparative | Comparative | Comparative |
|---|---|---|---|---|---|---|---|---|
| | | Example 1 | Example 2 | Example 3 | Example 4 | Example 5 | Example 6 | Example 7 |
| Polyolefin resin | | 100 | 100 | 100 | 100 | 100 | 100 | 100 |
| Metal hydroxide-based flame | | 60 | 60 | 60 | 60 | 60 | 150 | 60 |
| retardant | | | | | | | | |
| Antioxidant 1 | | 1 | 1 | 1 | 1 | 1 | 1 | 1 |
| Antioxidant 2 | | 1 | 1 | 1 | 1 | 1 | 1 | 1 |
| Copper inhibitor | | 0.5 | 0.5 | 0.5 | 0.5 | 0.5 | 0.5 | 0.5 |
| A-type zeolite | | 0.5 | 0.5 | 0.5 | 0.5 | 0.5 | 0.5 | 3 |
| Beta-type zeolite | | | | | | | | |
| Y-type zeolite 1 | | | | | | | | |
| Y-type zeolite 2 | | | | | | | | |
| Organically modified bentonite | | | | | | 15 | 5 | 5 |
| Purified bentonite | | 5 | | | | | | |
| Mica | | | 5 | | | | | |
| Calcined kaolin clay | | | | 5 | | | | |
| Wollastonite | | | | | 5 | | | |
| Evaluation | Electric wire heat | Fail | Fail | Fail | Fail | Fail | Fail | Pass |
| | resistance | | | | | | | |
| | Bleed resistance | Pass | Pass | Pass | Pass | Pass | Pass | Pass |
| | Thermal deformation | Pass | Pass | Pass | Pass | Pass | Pass | Pass |
| | properties | | | | | | | |
| | Water absorption | Pass | Pass | Pass | Pass | Pass | Pass | Fail |

| | | Comparative | Comparative | Comparative | Comparative | Comparative | Comparative |
|---|---|---|---|---|---|---|---|
| | | Example 8 | Example 9 | Example 10 | Example 11 | Example 12 | Example 13 |
| Polyolefin resin | | 100 | 100 | 100 | 100 | 100 | 100 |
| Metal hydroxide-based flame | | 60 | 60 | 60 | 60 | 60 | 60 |
| retardant | | | | | | | |
| Antioxidant 1 | | 1 | 4 | 1 | 1 | 1 | 1 |
| Antioxidant 2 | | 1 | 1 | 2 | 1 | 1 | 1 |
| Copper inhibitor | | 0.5 | 0.5 | 0.5 | 0.5 | 0.5 | 0.6 |
| A-type zeolite | | 0.5 | 0.5 | 0.5 | 2 | | |
| Beta-type zeolite | | | | | | | |
| Y-type zeolite 1 | | | | | | | |
| Y-type zeolite 2 | | | | | | | 0.5 |
| Organically modified bentonite | | | | | | 5 | 5 |
| Purified bentonite | | | | | | | |
| Mica | | | | | | | |
| Calcined kaolin clay | | | | | | | |
| Wollastonite | | | | | | | |
| Evaluation | Electric wire heat | Fail | Pass | Pass | Fail | Fail | Fail |
| | resistance | | | | | | |
| | Bleed resistance | Pass | Pass | Fail | Pass | Pass | Pass |
| | Thermal deformation | Pass | Fail | Pass | Pass | Pass | Pass |
| | properties | | | | | | |
| | Water absorption | Pass | Pass | Pass | Pass | Pass | Pass |

As shown in Table 1, the resin compositions according to Example 1 to Example 10 were excellent in all of electronic wire heat resistance, bleed resistance, thermal deformation properties, and water absorption. From these results, it is assumed that the resin compositions according to Example 1 to Example 10 had sufficient heat resistance and bleed resistance for use as a coating layer of an electric wire.

On the other hand as shown in Table 2, the resin compositions according to Comparative Example 1 to Comparative Example 13 were insufficient in at least one of electronic wire heat resistance, bleed resistance, thermal deformation properties, and water absorption. In Comparative Examples 1 to 4, no organically modified layered silicate was contained and non-organically modified purified bentonite, mica, calcined kaolin clay, or wollastonite was contained. Thus, electronic wire heat resistance was evaluated as “fail”. In Comparative Example 5, the content amount of the organically modified layered silicate with respect to 100 parts by mass of the polyolefin resin was more than 14.0 parts by mass, and hence electronic wire heat resistance was evaluated as “fail”. In Comparative Example 6, the content of the metal hydroxide-based flame retardant with respect to 100 parts by mass of the polyolefin resin was more than 140 parts by mass, and hence electronic wire heat resistance was evaluated as “fail”. In Comparative Example 7, the content of the zeolite is more than 2.0 parts by mass, and hence water absorption was evaluated as “fail”. In Comparative Examples 8 to 11, only the zeolite was used as the inorganic filler without using the organically modified layered silicate, and hence electronic wire heat resistance, at least one of bleed resistance and thermal deformation properties was evaluated as “fail”. In Comparative Example 12, only the organically modified layered silicate was used as the inorganic filler without using the zeolite, and hence electronic wire heat resistance was evaluated as “fail”. In Comparative Example 13, the zeolite having a pore diameter of 9 Å and a silica/alumina ratio of more than 10 was used, and hence electronic wire heat resistance was evaluated as “fail”.

From these results, it can be understood that, when the resin composition is obtained by blending specific components in a specific composition, sufficient heat resistance and bleed resistance for use as a coating layer of an electric wire can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A resin composition comprising:
a polyolefin resin;
a metal hydroxide-based flame retardant;
an inorganic filler; and
an antioxidant, wherein
a content of the metal hydroxide-based flame retardant is 60 parts by mass or more and 140 parts by mass or less with respect to 100 parts by mass of the polyolefin resin,
the inorganic filler is formed by using zeolite and an organically modified layered silicate in combination,
a content of the zeolite is 0.5 parts by mass or more and 2.0 parts by mass or less with respect to 100 parts by mass of the polyolefin resin,
the zeolite has a pore diameter of 3.0 Å or more and 6.5 Å or less, or a pore diameter of more than 6.5 Å and 9.0 Å or less, and has a silica/alumina ratio of 2 or more and 10 or less, and
a content of the organically modified layered silicate is 1.0 part by mass or more and 14.0 parts by mass or less with respect to 100 parts by mass of the polyolefin resin.

2. The resin composition according to claim 1, wherein
the polyolefin resin is polyethylene or an ethylene copolymer resin that is subjected to a crosslinking treatment.

3. The resin composition according to claim 1, wherein
the metal hydroxide-based flame retardant is magnesium hydroxide.

4. The resin composition according to claim 1, wherein
the organically modified layered silicate is bentonite or smectite that is modified with an organic onium salt.

5. A coated electric wire comprising:
a conductor; and
a coating layer that covers the conductor and contains the resin composition according to claim 1.

6. A wire harness comprising the coated electric wire according to claim 5.
